(19) United States
(12) Patent Application Publication
(10) Pub. No.: US 2018/0341380 A1
(43) Pub. Date: Nov. 29, 2018

(54) SYSTEM, METHOD, AND APPARATUS FOR CONFIGURING ATTRIBUTES OF INTERFACE ELEMENTS

(71) Applicant: Alibaba Group Holding Limited, George Town (KY)

(72) Inventors: Xushu Lu, Beijing (CN); Kong Ruan, Beijing (CN); Ruijie Li, Hangzhou (CN); Junlin Tian, Beijing (CN)

(21) Appl. No.: 15/995,685

(22) Filed: Jun. 1, 2018

Related U.S. Application Data
(63) Continuation-in-part of application No. PCT/CN2016/107595, filed on Nov. 29, 2016.

(30) Foreign Application Priority Data
Dec. 9, 2015 (CN) 201510908199.2

(51) Int. Cl. G06F 3/0484; G06F 3/0481; G06F 9/54

(52) U.S. Cl. CPC G06F 3/0484; G06F 3/04812; G06F 9/542; G06F 3/04817

(57) ABSTRACT

A method for configuring attribute associated with interface elements, including: obtaining a notification, the notification including attribute value associated with the one or more interface elements; and transmitting the notification to a receiving entity such that the receiving entity is caused to configure one or more attributes associated with interface elements based at least in part on the attribute value associated with the one or more interface elements.

### CROSS REFERENCE TO OTHER APPLICATIONS

This application is a continuation in part of and claims priority to International (PCT) Application No. PCT/CN16/107595 entitled METHOD FOR SETTING ATTRIBUTE VALUE OF INTERFACE ELEMENT, AND APPARATUS AND SMART DEVICE THEREFOR, filed Nov. 29, 2016 which is incorporated herein by reference for all purposes, which claims priority to China Application No. 201510908199.2 entitled A METHOD AND MEANS FOR SETTING ATTRIBUTE VALUES OF INTERFACE ELEMENTS AND A SMART DEVICE, filed Dec. 9, 2015 which is incorporated herein by reference for all purposes.

### FIELD OF THE INVENTION

The present application generally relates to the field of computer technology and more particularly, to a system, method, and apparatus for configuring attributes of elements of a user interface.

### BACKGROUND OF THE INVENTION

Presently, changes to the visual stylings of the elements displayed in a user interface (UI) are usually effectuated by the downloading and subsequent installation of an UI resource package (e.g., a theme pack). In general, a user identifies a UI resource package that includes one or more themes or features of interest (e.g., a theme pack offering a new set of wallpapers, launchers, widgets, icon packs, sound effects, and so on), and then has to resort to downloading the entire resource package or content file, thereby installing the entire look and feel provided by the theme pack. As such, when a user wants to change one or few aspects of the visual stylings of his or her current interface display, the user nevertheless has to download and install another entire UI resource package in order to customize the particular visual aspects of the interface.

The reliance on the use of a resource package or content file by the conventional techniques imposes a cumbersome requirement upon users who are only interested in customizing a limited number of visual elements of the UI on his or her terminal device. Furthermore, because such a resource package or content file is typically designed towards achieving an overall look and feel of a user interface, all the UI resources deployed in the interface have to be compiled in the corresponding resource packages or content files. As such, the storage footprint of a resource packages or content files tend to be large, and the downloading and the installation of resource packages tend to incur a substantial amount of computing resource usage on a terminal device.

Therefore, there exists a need for a light-weighted, flexible, and computing resource economic mechanism for a user to configure attributes associated with elements of an interface.

### BRIEF DESCRIPTION OF THE DRAWINGS

Various embodiments of the invention are disclosed in the following detailed description and the accompanying drawings.

The drawings described here are intended to further the understanding of the present application and form a part of the present application. The illustrative embodiments of the present application and the descriptions thereof are intended to explain the present application and do not constitute inappropriate limitation of the present application. Among the drawings:

FIG. 1A is a flow chart illustrating an example process for configuring attributes associated with interface elements, in accordance with one or more embodiments of the present disclosure.

FIG. 1B is a schematic diagram illustrating two example interfaces having interface elements associated with respective element identifiers, in accordance with one or more embodiments of the present disclosure.

FIG. 2 is a flow chart illustrating an example process for configuring attributes associated with interface elements, in accordance with one or more embodiments of the present disclosure.

FIG. 3 is an interactive diagram illustrating an example process for configuring colors associated with interface elements, in accordance with one or more embodiments of the present disclosure.

FIG. 4 is a functional diagram illustrating an example system for configuring attributes of interface elements, in accordance with one or more embodiments of the present disclosure.

FIG. 5 is a functional structural diagram illustrating another example system for configuring attributes of interface elements, in accordance with one or more embodiments of the present disclosure.

FIG. 6 is a functional diagram illustrating an embodiment of a programmed computer system for configuring attributes associated with interface elements, in accordance with one or more embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique for configuring attributes of the elements of an interface display is described herein. In various embodiments, the configuration of attributes associated with interface elements is performed by a software application executing on a user terminal device. Such an application can be, for example, an application in the core package included in the operating system of the terminal device, an application installed by the service carriers, an application developed by a third party vendor/developer (third party application), or the like. For the simplicity of illustration, various embodiments are described from the perspective of a third party application. It should be understood that embodiments of the present disclosure can be applied to any application or processes that are capable of adjusting attributes associated with interface elements without limitation.

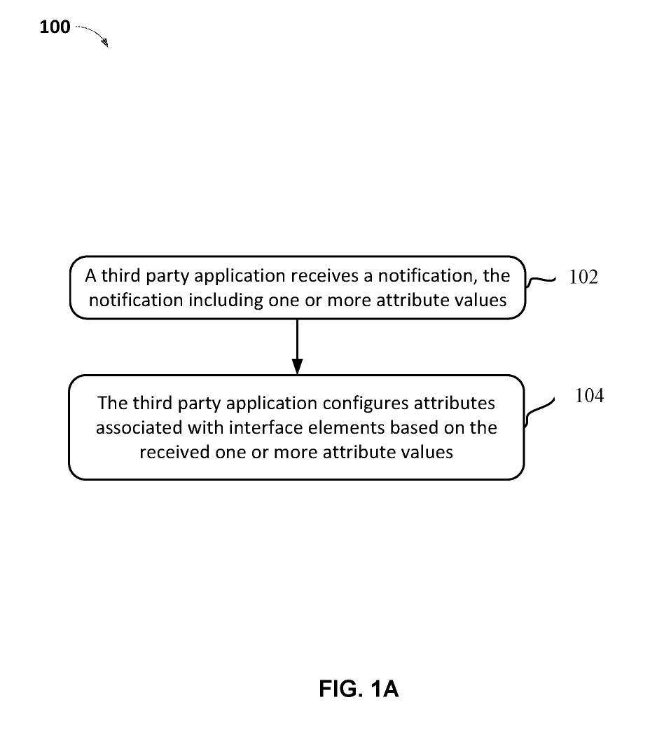

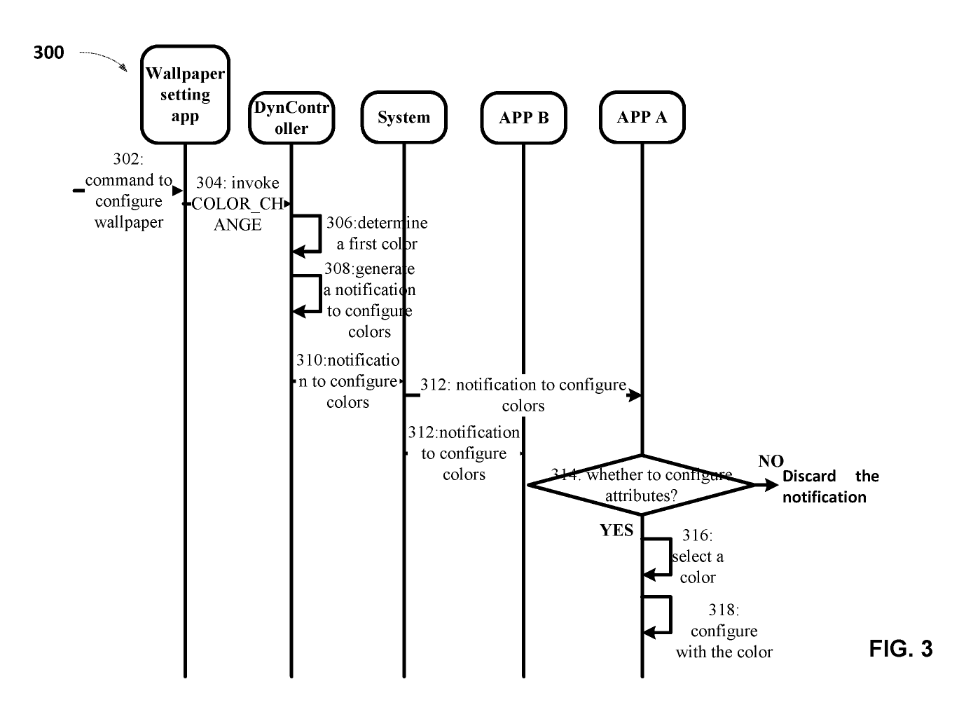

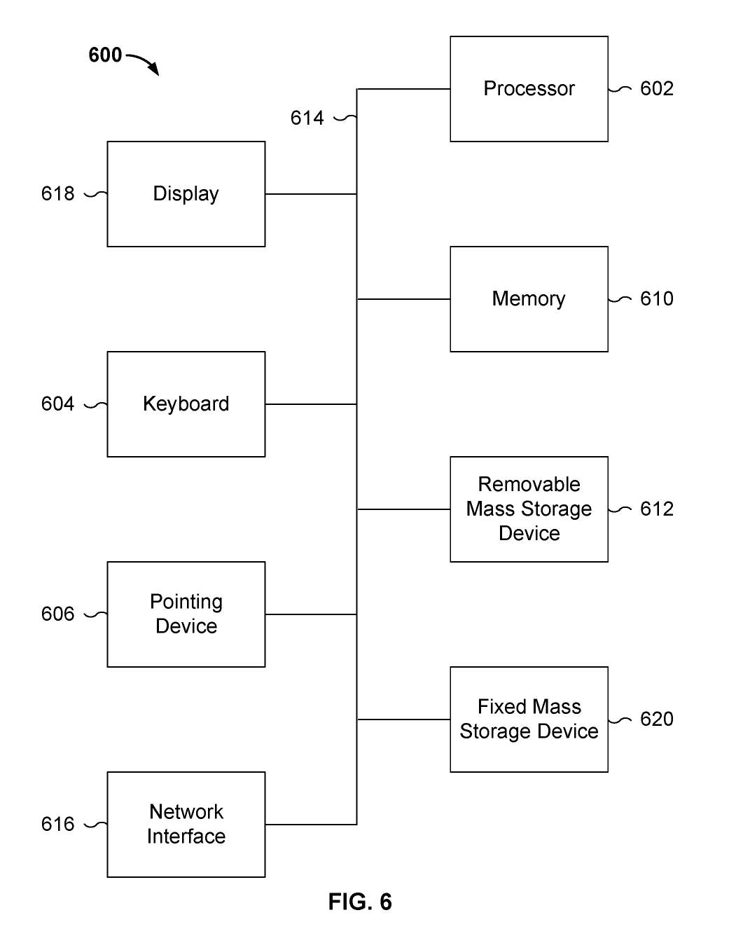

FIG. 1A illustrates a flow chart of an example process for configuring attributes associated with interface elements in accordance with an embodiment of the present disclosure. Process 100 can be implemented by, for example, system 400 of FIG. 4, or system 600 of FIG. 6.

Process 100 starts at 102, where a third party application is configured to receive a notification to configure values for attributes associated with interface elements of the third party application. In this example, the notification is configured to include the attribute values to be used to configure the corresponding attributes of interface elements. For simplicity of illustration, the attribute values include values corresponding to at least one of a color, a brightness level, and an opacity level. It should be understood that the notification can include any number of attribute values corresponding to any number of attributes.

As used herein, the term “attribute” refers to a visual characteristic of a display interface. For example, an attribute can include a color (e.g., background, foreground, focus, selection foreground, selection background, etc.), a brightness level, an opacity level, a font (e.g., size, style, typeface, weight, etc.), an icon size, an icon shape, a background image (wallpaper), a sound effect, a menu layout, and the like.

As used herein, the term “interface element” or “element” refers to a component or a group of components of a user interface. For example, an interface element can include a button, a title bar, a toolbar, a selection box, a switch, a slider, a progress bar, an input box, a check box, radio buttons, a navigation image such as a scroll arrow, a status icon, an animation, a toast, any other interface component that can achieve a predetermined display effect, or any other appropriate interface component that can achieve a predetermined display effect with a picture configured as a background image.

In some embodiments, the configuration of attribute values applies to the operation of configuring values of attributes associated with background pictures of the interface. In this case, the configurable attributes include, for example, the size of the picture, the shape of the picture, the color of the picture, and the like. In some implementations, the attributes associated with a picture of the interface can be customized based on, for example, a visual effect previewed in conjunction with the interface elements. Such a picture can be in the format of a bitmap file, a vector graphic file, a raster graphic file, or the like. Such a picture may or may not possess texture features or shape features.

In some embodiments, the notification is transmitted from the operating system of the terminal device at which the interface is displayed. In some other embodiments, the notification is transmitted from other applications to the third party applications. In various embodiments, the notification can be transmitted in a broadcast manner to multiple other applications in addition to the third party application, or in a unicast manner targeting only the third party application. In some embodiments, the notification includes an identification corresponding to the third party application, which in turn utilizes the identification to determine that the notification is targeting itself as the receiving application.

In some embodiments, the notification is generated by a pre-configured interface provider, which is configured to provide an interface (e.g., an application programming interface (API)) at which values of the attributes associated with interface elements can be exchanged or obtained. For example, such an interface can be coded as an interface of “COLOR_CHANGE” to specifically provide for values associated with color settings. Once invoked, the interface is configured to generate the above-described notification, the notification including specific values corresponding to the attributes specifically configured at the interface. Next, the interface provider is configured to invoke a first messaging interface (e.g., updateConfiguration) to transmit the notification to the operating system. Subsequently, the operating system is configured to invoke a second messaging interface (e.g., onConfigurationChange/onCreate) to transmit the notification to the third party application.

In some other embodiments, the notification is generated by the operating system. For example, the operating system can be configured to respond to a triggering condition to generate a notification to configure attributes of interface elements. Such a triggering condition includes, for example, receiving a command to configure the wallpaper setting, a command to configure the theme setting, or a command from a server to re-configure attribute values, and the like. Triggering conditions can be generated by a user selection operation, by another application, by a remote application, by a particular context such as a date and a location, or the like.

In some embodiments, a command to configure the theme of the display includes various options of the themes corresponding to various colored themes. A user's selection of a theme option by, e.g., a user clicking on the selectable option or a user gesture command, is configured to trigger the command to configure the theme for the display interface.

In some embodiments, the operating system is configured to utilize pre-configured attribute values or the received attribute values to generate a notification that includes such attribute values. Taking the opacity attribute for example, the operating system can be configured to retrieve a previously stored value corresponding to the opacity level of a status bar (e.g., a default level pre-configured for that particular device type and make by the manufacturer), and generate a notification to include the retrieved pre-configured opacity level of the status bar as the included attribute value. In some embodiments, the operating system is configured to further modify the default opacity level based on other conditions (e.g., battery level, etc.), and generate the notification to include the modified value of opacity level as the included attribute value.

Taking the color attribute for another example, the operating system can be configured to generate a color based on which a notification is generated to include the generated color as the included attribute value. For simplicity of illustration, three example mechanisms by which the operating system is configured to generate a value for the color attribute that can be used to configure interface elements are described in the following. It should be understood that any suitable techniques can be applied to generate color values for the purpose of configuring attributes associated with interface elements without limitation.

In the first example, the operating system is configured to generate a color based on a specified picture. In some embodiments, such a picture can be any image that can be set as a background display at the interface. In this case, the configurable attributes include, for example, the size of the picture, the shape of the picture, the color of the picture, and the like. In implementation, the attributes associated with a picture of the interface can be customized based on, for example, a visual effect previewed in conjunction with the interface elements. Such a picture can be in the format of a bitmap file, a vector graphic file, a raster graphic file, or the like. Such a picture may or may not possess texture features or shape features.

A specified picture can include, for example, a picture saved locally at the user's terminal device, an image currently set as the wallpaper (e.g., the desktop wallpaper, the lock screen wallpaper, etc.) at the user's terminal device, a picture selected by the user from an image displayed online, or a picture received by the user in messaging applications such as E-mail, SMS, etc.

When the specified picture is determined by a user's selection of a particular picture, the user's terminal device is configured to determine the particular picture as the specified picture in response to the user selection operation. Commands to perform user selection operations of a picture includes, for example, a user clicking on a picture, a user gesture at a picture, a user voice command to click on a picture, or the like.

In some embodiments, artificial intelligence (AI) or the technologies alike are used to automatically specify a picture as the specified picture for the user, or recommend and obtain user's confirmation of the AI-selected specified picture.

In some embodiments, the specified picture is in the format of a bitmap file. In this scenario, each pixel of the specified picture is associated with a color value, which is also termed as a pixel color. A pixel color can be specified as, for example, a vector of one or more of values representing red, green, and blue (RGB values). Alternatively, a pixel color can be represented by one or more parameters determined based on the vector of RGB values.

In some embodiments, a target color is at least one color determined based on the pixel colors of a specified picture. In implementation, a user terminal device can be configured to set a particular pixel color of the specified picture as the target color. Alternatively, the user terminal device can be configured to compute an average color value based on all of the pixel colors of the specified picture, and set the computed average color value as the target color. The user terminal device can also be configured to perform statistical analysis to obtain a count of the pixels having different colors, and to set the pixel color associated with the largest pixel count as the target color. The user terminal device can also be configured to determine a pixel color corresponding to the color tone of a specified picture, and to set the determined color tone as the target color.

In some embodiments, a pixel color of a specified picture includes, for example, a color that is obtained by a terminal device via sampling the pixel colors associated with one or more areas of the specified picture.

As used herein, a color tone of a specified picture represents an overall shade of the color appearance of the specified picture. With a picture having multiple colors, there is an overall tone to the entire collection of color appearance. For example, a picture may in general exhibit hues that are either blueish or reddish, in warm colors (hues from red through yellow) or cool color (hues from blue green through blue violet) or neutral color (hues of gray, purple and white). Such general color appearance is designated as a color tone of a picture. A color tone can be classified generally as a “warm tone,” a “cool tone,” or a “neutral tone.” In particular, for a cool-colored picture, the higher the level of brightness, the lower the degree of coolness is exhibited. On the other hand, for a warm-colored picture, the higher the level of brightness, the lower the degree of warmness is exhibited.

In the second example, the operating system is configured to generate a target color based on a specified event.

A specified event includes a time and/or date based event such as public holidays, personal vacations, user's birthday, user's family member's birthday, colleague's birthday, voting day, time-specific reminder for appointments, and the like. A specified event can also include an event generated at a user's terminal device. For example, a specified event can include the receipt of SMS messages or email messages from a particular contact, the payment of a placed order for goods or services on the terminal device, the retrieval of weather forecast that indicates particular types of weather conditions (e.g., rainy or snowing), and the like. As shown in the afore-described examples, a specified event can be specified by a public calendar (a public holiday), or specified by a user (user's birthday, anniversary, etc.), or specified by a user other than the user of the terminal device (colleague's birthday on a shared calendar). In some embodiments, a specified event can also be specified by artificial intelligence (AI) or technologies alike, which are able to mine user behaviors and other data to automatically select an event as a specified event. For example, an AI assistant on a mobile phone can detect that a particular person has sent the user an excessive number of messages which the user has immediately deleted, without reading. As a result, the AI assistant is configured to either automatically designate the receipt of messages from that particular person as a specified event, or recommend to the user such that the user confirms for the AI assistant to designate a specified event associated with messages from that person.

In addition to designating a specified event, an attribute value is also designated to associate with the specified event. For example, a mapping relationship can be pre-configured between a specified event and a change in values of attributes associated with interface elements. When such an attribute is color, a mapping relationship is pre-configured between a specified event and a color. In response to the occurrence of the specified event, the color associated with an entry matching with the specific event in the mapping relationship is designated as the target color.

Take an incoming short message for example, the terminal device detects a specified event by detecting a particular user having sent an SMS message. Beforehand, the user has configured the color green as the color mapped to the specified event of receiving SMS messages from that particular sender. As such, it is determined that the color green is the target color, thereby color green is included in the notification generated by the operating system, and green is the color the third party application is to configure the color of its interface elements with. For example, the normal color tone of the user display is orange, then upon the arrival of the above-described SMS message, the color tone of the third party application becomes green.

In the third example, the operating system is configured to generate a target color based on user selections of colors.

For example, a user interface can be configured to provide the user with a color palette of at least two colors as options. In some embodiments, a color palette configured to include more than two colors is provided at the user interface. Based on the user's selection of at least one color from the color palette, a target color is designated by the operating system as the selected color from the palette.

Again, for the simplicity of illustration, only the determination of color attribute is described above. It should be understood that any types of attributes associated with interface elements can be generated and applied according to embodiments of the present disclosure without limitation.

Referring back to FIG. 1A, at 104, upon receiving the values of the attributes associated with interface elements, the third party application is configured to configure the attributes of its interface elements based on the received attribute values included in the notification.

In some embodiments, the third party application is configured to automatically apply the received values directly to configure attributes associated with interface elements of the third party application. In some embodiments, the third party application is configured to, based on further conditions, determine whether to apply the received values to configure attributes associated with the interface values of the third party application. For example, the third party application can be configured to determine whether to update the attributes associated with the interface elements based on the received attribute values included in the notification. Only if it is determined that the attributes are to be configured, the third party application updates the values of attributes associated with the interface elements. Otherwise, the third party application will not update attributes associated with interface elements based on the received values. In some embodiments, the third party application is configured to discard the notification upon the determination that the attributes associated with its interface are not to be updated.

For the simplicity of illustration, three example mechanism by which a third party application is configured to determine whether to modify attributes of its interface elements are described in the following. It should be understood that any suitable techniques can be applied by a third party application to make the determination without limitation.

With the first mechanism, a third party application is configured to obtain a pre-configured and stored set of policies that dictate how and whether attributes associated with interface elements are to be configured or reconfigured. Then, the third party application is configured to determine whether to configure attributes of its interface elements based on the attribute values included in a notification, according to the set of policies. If it is determined that the set of policies allows the attributes to be configured based on the attribute values included in the notification, the third party application updates the values of attributes associated with the interface elements accordingly. Otherwise, the third party application will not update attributes associated with interface elements based on the received attribute values.

For example, the third party application can be configured to verify whether the received attribute values apply to the elements of its interface in the context of its current display color. When a value indicating a change to warm color tone is received in the notification, if the third party application is already displayed in warm color tone, the third party application can ignore the received notification to reconfigure the color of its interface.

In some embodiments, the set of policies is configured by the third party application developers, and saved in a database associated with the third party application. In some embodiments, the set of policies is compiled through the course of the user's operation and interaction with the third party application, and/or applications other than the third party application. In some embodiments, the set of policies is specified based on contextual conditions of the user, the terminal device, or the like. In some embodiments, the set of policies is stored at a remote data store such as a cloud based storage.

With the second mechanism, a third party application is configured to determine whether the attribute values included in are applicable to its interface elements. If so, the third party application is configured to determine that the attributes associated with its interface elements can be updated based on the attribute values received in the notification. Otherwise, the third party application is configured to determine that the attributes associated with its interface elements cannot be updated based on the attribute values received in the notification.

In some embodiments, the second mechanism can be implemented by use of the above-described notification including element identifiers (IDs) for the attributes corresponding to the included attribute values. This way, upon receiving a notification, the third party application is configured to determine whether one or more element identifiers included in the notification match with those of any of its own interface elements. If so, the third party application determines that attributes associated with its interface elements can be updated based on the attribute values included in the notification. Otherwise, the third party application is configured to determine that the attributes associated with its interface elements cannot be updated based on the attribute values received in the notification.

In some embodiments, interface element IDs included in a notification can be pre-configured and assigned to various interface elements according to their respective functionalities. For example, interface elements of different applications can be categorized and organized into interface element types, such as title zones, control zones, toolbars, and the like, each corresponding to different interface functionalities. Subsequently, different interface element IDs can be assigned to the corresponding interface elements such that different interface element IDs represent interface elements having different functionality, and the same interface element IDs represent interface elements having the same functionality.

FIG. 1B illustrates two example interfaces having interface elements associated with respective element identifiers in accordance with an embodiment of the present disclosure. As shown herein, interface 122 is associated with APP 1, and interface 124 is associated with APP 2. Both interface 122 and interface 124 include multiple interface elements. As shown herein, region 142 of interface 122 and region 162 of interface 124 are both designated as a title region; region 144 of interface 122 and region 164 of interface 124 are both designated as a control region; and region 146 of interface 122 and region 166 of interface 124 are both designated as a toolbar region. As such, even though these regions are rendered with different sizes and/or shapes in interface 122 and interface 124, these regions are uniformly designated with identifiers of “HEAD,” “MAIN,” and “TOOLBAR,” respectively, based on the identified functionalities associated therewith.

At present, in order to customize attributes associated with the visual effects associated with interface elements, developers have to design for each application on an individual basis using the conventional techniques. For example, a UI designer typically needs to set forth different identifiers corresponding to different regions in an interface of an application, and to establish a mapping relationship between various identifiers and resources. Subsequently, application developers need to pack the mapping relationship together with the resources into a theme package or a UI content file. As such, both the designer and developer are tasked with a large amount of work in terms of coordinating the design and development, also any adjustments to an application interface will invalidate the original identifiers and therefore also invalidate the mapping relationships between the identifiers and resources. In this case, the designer needs to revisit the afore-described first step of assigning identifiers and establishing the mapping relationships between the identifiers and resources. Correspondingly, the developer needs to pack the new mapping relationships and resources into an upgrade theme package (e.g., a skin pack) or a UI content file.

In contrast, according to various embodiments of the present disclosure, a UI designer no longer needs to establish the mapping relationship between the identifiers and the resources. Instead, interface element identifiers are assigned to various elements occupying different regions of an interface. As described above in connection to the second example mechanism, based on the element identifier, the application can be configured to determine whether its interface includes an element corresponding to a particular element identifier for the purposes of determining whether to configure the attributes associated with its interface elements.

Compared to the conventional techniques, the use of assigning element identifiers to various elements occupying respective regions in an interface of an application realizes a streamlined and simplified UI interface design and development, with the ability to conveniently customize attributes associated with the interface elements. As a result, less time, effort, and cost are needed towards designing and developing applications with interfaces, especially for the interfaces that might benefit from frequent updates.

In various embodiments, any suitable techniques can be applied to configure attributes associated with interface elements of a third party application with the values received in a notification. In some embodiments, a third party application is configured to apply the attribute values included in a received notification to a portion of or the entire collection of its interface elements. In some embodiments, the third party application is configured to compute values for other attributes based on a pre-configured first mapping relationship. With the computed values for these other attributes, the third party application subsequently updates a portion of or the entire collection of its interface elements.

In some embodiments, the first mapping rule can be implemented as a one to one relationship. In some embodiments, the first mapping rule can be implemented by use of formulas or any suitable algorithms without limitation.

For an example where the notification includes at least two attribute values, attributes associated with the interface elements of a third party application can be configured by using the following example mechanisms.

First, the third party application can be configured to select attribute values from the at least two attribute values, and configure the attributes of its interface elements with the selected attribute values. In this scenario, the third party application is configured to directly apply the selected attribute values to the attributes of its interface elements. Second, the third party application can be configured to use a pre-configured second mapping rule to compute values corresponding to other attributes, based on the selected attribute values. Subsequently, the third party application is configured to customize a portion or the entire collection of its interface elements by use of the computed attribute values. For example, the second mapping rule can be implemented as, when a brightness level is changed by a particular percentage, the opacity level is to be changed automatically to another percentage to ensure the consistency of the look and feel of the interface.

In some embodiments, in order to ensure the visual harmony amongst different interface elements once the configuration of attributes is done, the notification can be configured to include, in addition to the attribute values, interface element identifiers that correspond to their respective attribute values. As such, the notification further specifies how interface elements are mapped to respective attribute values. For example, the notification can dictate that the attribute value of color “blue” is mapped to the interface element of “control,” the attribute value of color “white” is mapped to the interface element of “title bar,” and so on.

This way, the third party application is configured to select, from the notification, attribute values having corresponding element identifiers that match with the element identifiers of its interface elements. With the selected set of attribute values from the notification, the third party application is configured to subsequently configure the attributes associated with its interface elements having the matching identifiers corresponding to the selected set of attribute values.

For example, the third party application selects the attribute value of color “blue,” and the color “blue” is mapped to the element identifier of “KJ” (an internal color identifier) in the notification. The third party application in turn applies the color “blue” to the attribute of its interface elements associated with the identifier of “KJ.” In particular, if the interface elements of control are associated with the identifier of “KJ,” the third party application applies the color “blue” to the controls in its interface.

In the case where the notification includes both the attribute values and the element identifiers of their respective interface elements, and where the third party application is configured with one or more elements in its interface that have the same element identifiers, the third party application can be configured to apply the attribute values directly to the corresponding matching elements of its interface, without performing a selection of the attribute values first.

Again, any suitable techniques can be used to configure identifiers for the interface elements without limitation. In some embodiments, the interface element identifiers are configured based on the functionalities of the elements as described above. In some embodiments, the interface element identifiers can be configured based on other aspects describing or representing the elements.

In some embodiments, the third party application is configured to, in addition to receiving the notification, forward the received notification to another application. In turn, the other application is configured to determine whether to customize the attributes associated with its interface elements based on the attribute values received in the notification. For example, the third party application can transmit a notification to another application via invoking an API call (e.g., the above described second interface “onConfigurationChange/onCreate”).

According to various embodiments, the use of receiving notifications including attribute values, and of updating the attributes associated with interface elements based on the received attribute values, eliminates the requirement or need to generate or download UI resource packages or content files. As such, to update or configure a user interface at a terminal device becomes more convenient and incurs less usage of computing resources.

Further, after obtaining the attribute values from the notification, a third party application is configured to further determine whether to apply the obtained attribute values to the attributes associated with its interface elements. In some embodiments, the third party application applies the obtained attribute values to the attributes of its entire interface elements; in some embodiments, the third party application applies only a portion of the obtained attribute values to the attributes of a portion of its interface elements.

On the other hand, from the perspective of third party applications, any newly available or installed applications that are interested in having their interface elements configured can have the notification transmitted thereto. Similarly, any applications that are no longer interested in having their interface elements configured can either be removed from receiving the notification, or discard the received notification. As such, particular applications and particular elements to be configured with attribute values can be implemented easily and flexibly.

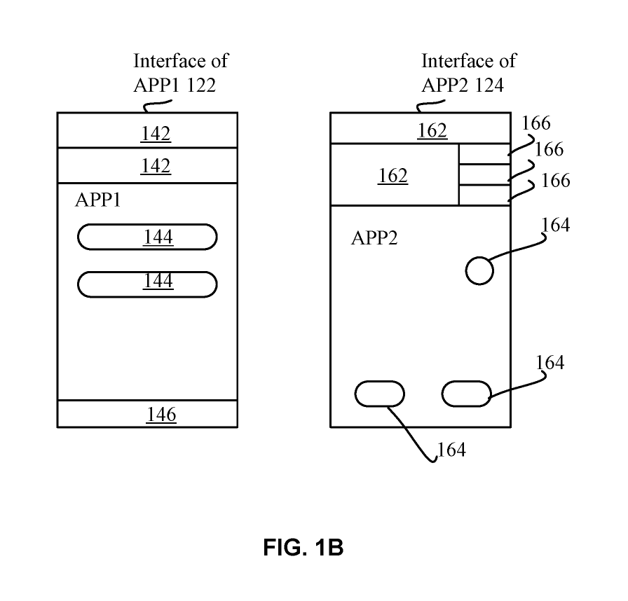

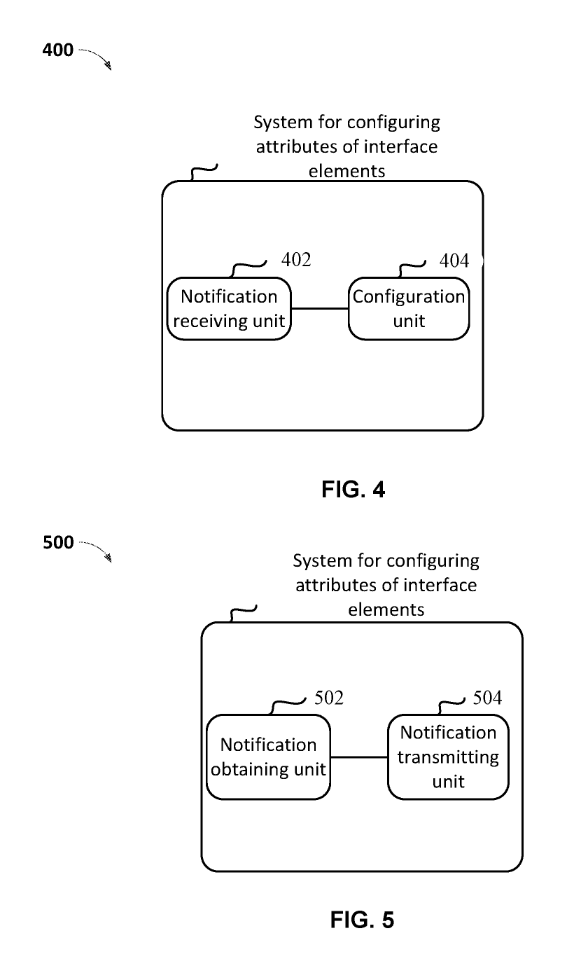

FIG. 2 illustrates another example process for configuring attributes associated with interface elements in accordance with an embodiment of the present disclosure. Process 200 can be implemented by, for example, system 500 of FIG. 5, or computing system 600 of FIG. 6.

Process 200 starts at 202, where an operating system of a terminal device is configured to obtain a notification.

In this example, the notification includes one or more attribute values, which are used to configure attributes associated with interface elements. Similar to the description with reference to FIG. 1A, attributes associated with interface elements refer to any attributes of visual effects, including, for example, color, brightness level, and opacity level.

In various embodiments, any number of attribute values can be included in the notification, without limitation. In some embodiments, the attribute values specified in the notification include at least one of the following: a color value, a brightness level value, and an opacity level value.

In some embodiments, the operating system is configured to generate the notification. In some embodiments, the operating system is configured to receive the notification.

In the first example, the operating system can be configured to generate a notification in response to a triggering event or condition. For example, such a triggering event can include a command to configure a wallpaper setting, to configure a theme setting, to configure a ringtone setting, to configure a text size/font setting, to update attributes based on notifications transmitted from a server, or the like. In particular, a command to configure a theme setting can be triggered by a user's selection operation upon the options presented to the user as the available or recommended themes.

In various embodiments, the operating system is configured to generate the notification based on the pre-configured attribute values or obtained attribute values. Take the attribute of color for example, the operating system can be configured to determine a target color, which is used to generate a notification that includes the target color.

Similar to the mechanism described with reference to FIG. 1A, the target color can be determined based on a specified picture, a specified event, and/or a user selection of a color. Therefore, for simplicity of illustration, details of these mechanisms are not repeated herein.

In the second example where the operating system is configured to receive the notification, any suitable techniques can be applied without limitation. For example, the operating system can be configured to receive the notification generated by a pre-configured interface provider, which is configured to provide an interface (e.g., an application programming interface (API)) at which values of the attributes associated with interface elements can be exchanged or obtained. For example, such an interface can be coded as an interface of “COLOR_CHANGE” to specifically provide for values associated with color settings. Once invoked, the interface is configured to generate an above-described notification, the notification including specific values corresponding to the attributes specifically configured at the interface. Next, the interface provider is configured to invoke a first messaging interface (e.g., updateConfiguration) to transmit the notification to the operating system. Subsequently, the operating system is configured to invoke a second messaging interface (e.g., onConfigurationChange/onCreate) to transmit the notification to the third party application.

At 204, the operating system is configured to transmit the notification such that, upon the receipt of the notification, an application is caused to configure attributes associated with its interface elements based on the attribute values included in the notification.

In some embodiments, the notification is transmitted by use of a broadcast protocol. In some embodiments the notification is transmitted to a particularly targeted application.

The receiving application can be configured to directly apply the received attributes values to the attributes of its interface elements. Alternatively, the receiving application is configured to further determine whether to configure the attributes of its interface elements based on the received attribute values. If so, the receiving application is configured to update the attributes of its interface elements based on the received attribute values. Otherwise, the receiving application is configured not to update the attributes of its interface elements by, for example, discarding the notification.

The determination of whether to configure the attributes of the interface elements, the configuration of the attributes of the interface elements based on the received attribute values by the receiving application, and the use of element identifiers in the notification are all similar to those described with reference to FIGS. 1A-1B. Therefore, for simplicity of illustration, details of these determinations are not repeated herein.

In some embodiments, the configuration of element identifiers can be implemented based on the functionality associated with the interface elements. It should be understood that other suitable techniques can also be applied without limitation.

To configure the element identifiers, the functionality of different interface elements of an application is first determined.

For the interface elements that are associated with the same functionality, the same interface element identifier is configured for these interface elements, while interface elements having different functionality are assigned with different element identifiers.

In some embodiments, upon receiving the notification transmitted from the operating system, if the receiving application is caused to configure the attributes associated with its interface elements based on the received attribute values, the operating system is further configured to log the attribute values that have been applied by the receiving application, the element identifiers corresponding to the applied attribute values, or both. As such, when later triggered as above-described, the operating system can be configured to update the attributes of the interface elements of the receiving application directly, without generating a notification. This way, the operating system is able to configure the attributes of elements of an interface of an application.

According to various embodiments, the use of transmitting notifications including attribute values and causing a receiving application to update the attributes associated with its interface elements based on the received attribute values, eliminates the requirement or need to generate or download UI resource package or content files. As such, to update or configure a user interface at a terminal device becomes more convenient and incurs less usage of computing resources.

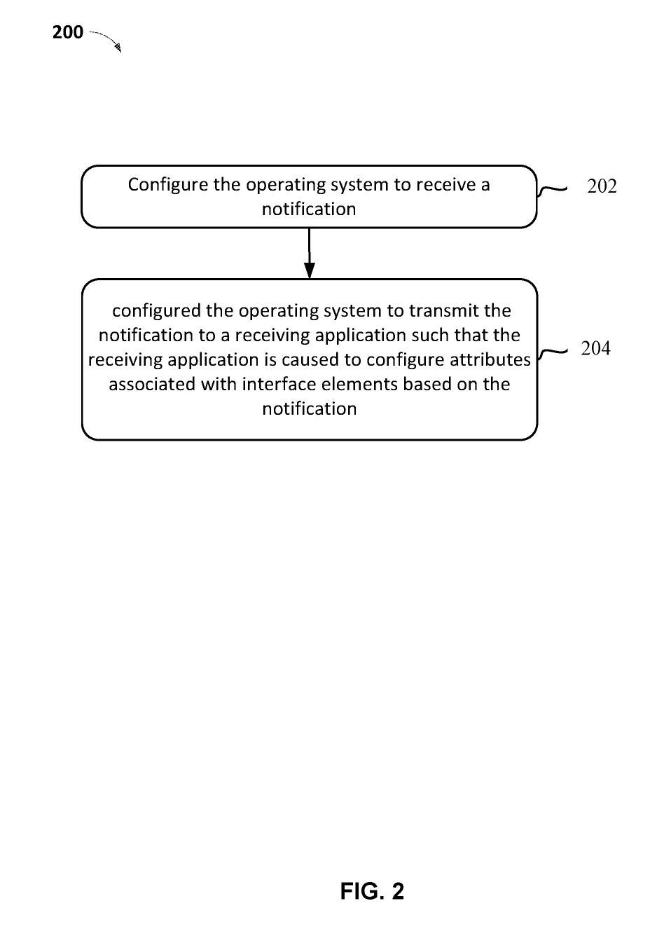

FIG. 3 illustrates an interactive diagram of an example process for configuring an attribute associated with interface elements in accordance with an embodiment of the present disclosure. In this example, a user has installed on a terminal device an application APP A and an application APP B. The operating system of the terminal device is configured to, in response to receiving a command to configure a wallpaper setting, transmit to both APP A and APP B a notification to configure the color attribute. Process 300 can be implemented by, for example, system 400 of FIG. 4, system 500 of FIG. 5, or computing system 600 of FIG. 6.

Process 300 starts at 302, where the user performs a selection operation of a wallpaper setting application to, for example, designate a locally saved picture as the image of the desktop wallpaper. The user's operation of selecting a wallpaper image triggers the wallpaper setting application to receive a corresponding command to configure a wallpaper setting.

At 304, in response to the command to configure a desktop wallpaper, the wallpaper setting application is configured to, in addition to setting the selected picture as the image of the desktop wallpaper, invoke the interface of “COLOR_CHANGE” provided by DynController.

At 306, in response to the desktop wallpaper setting application invoking the interface of “COLOR_CHANGE,” DynController is configured to determine a first color based on the pixel colors of the image currently designated as the desktop wallpaper.

In various embodiments, the first color is determined as one color based on the pixel colors of the desktop wallpaper image. In some embodiments, the first color is determined as a color associated with a span of color range based on the pixel colors of the desktop wallpaper image. In some embodiments, DynController is configured to designate one or more pixel colors of the desktop wallpaper image as the first color. In some embodiments, DynController is configured to compute an average value based on all the pixel colors of the desktop wallpaper image, and designate the computed average color value as the first color. In some embodiments, DynController is configured to perform statistical analysis to count the number of pixels having different colors, and designate the color corresponding to the largest pixel count as the first color. In some embodiments, DynController is configured to determine a color corresponding to the theme tone or color tone of the desktop wallpaper image, and designate that color tone as the first color. In some embodiments, DynController is configured to determine the first color by sampling the pixel colors of one or more areas of the desktop wallpaper image.

Again, the color tone of a picture is similar to the color tone as above-described with reference to FIG. 1A. Therefore, details of a color tone and the determination of a color tone are not repeated herein for the simplicity of illustration.

At 308, DynController is configured to generate a notification to signal color configuration based on the first color.

In some embodiments, the notification is generated to include the first color itself as the attribute value. In some embodiments, the notification is generated to include a second color that is determined, based on the first color, with reference to a mapping relationship. The mapping relationship maps the first color to at least one second color by use of a one to one mapping relationship, or a formula that converts the first color into a corresponding second color.

In implementation of the usage of a second color, collections of colors can be pre-configured to correspond to respective ranges of colors (e.g., establish a first mapping relationship between the collection and a range of colors). Here, each collection of colors includes at least one color, and each of the colors included in a collection corresponds to an above-described second color that can be determined based on the above-described first color. In some embodiments, a complete set of the collections of colors is referred to as a system guideline color spectrum. Given the first color and a span of color range, a range of colors to which the first color belong can be determined based on the afore-mentioned guideline color spectrum. Based on the first mapping relationship, a collection of colors matching with the determined range of the colors can be determined based on the system guideline color spectrum. Finally, a second color is determined as one of the colors of the determined collection of colors.

In some embodiments, multiple colors (e.g., multiple first colors and/or multiple second colors) are included in the notification for color configuration. In some other embodiments, the notification is also configured to further include interface element identifiers corresponding to their respective colors.

At 310, DynController is configured to transmit the generated notification to the system by invoking a first messaging interface of “updateConfiguration.”

At 312, upon receiving the notification, the system is configured to transmit the notification to APP A and APP B by invoking a second messaging interface of “onConfigruationChange/onCreate.”

For simplicity of illustration, the remaining steps of process 300 are described from the perspective of APP A only. It should be understood that APP B or any other receiving applications or processes (not shown) can be implemented to configure the attributes associated with their interface elements using the received notification.

At 314, in response to the received notification, APP A is configured to obtain a pre-configured set of configuration rules that is saved locally. Based on the obtained set of configuration rules, it is determined whether APP B is allowed to configure the colors associated with its interface elements based on the color received in the notification. If so, process 300 continues to 316; otherwise process 300 concludes and discards the received notification.

At 316, APP A is configured to select colors which are associated with respective element identifiers matching with that of APP A's interface elements.

At 318, APP A is configured to update the colors of its interface elements based on the selected colors. In implementation, APP A can be configured to invoke the interface of “DynColorSetting,” which is used to trigger the system to obtain the interface element identifiers of the interface element and the corresponding attribute values APP A is to update the elements with. And process 300 concludes at 318.

In terms of the subsequent operations, when APP A is to be rendered for displaying its interface elements which have been configured with the above-described colors, APP A is configured to execute an operation of retrieval from a data store, where APP A saves its corresponding attribute values and element identifiers, and a determined color and its corresponding element identifiers. From the perspective of the operating system, the operating system is configured to intercept/enable this operation such that to obtain the determined color and its corresponding element identifiers. The operating system is further configured to provide the obtained color and element identifiers as an execution result returned from the operation of retrieval of APP A. In turn, APP A is configured to update the colors of its elements having the identifier matching with the returned element identifiers with the returned color.

According to various embodiments, the use of transmitting a notification including attribute values from the operating system to an application results in the application being able to configure attributes associated with its interface elements based on the notification from the operating system. This way, the requirement or need to generate or download UI resource packages or content files is eliminated. As such, to update or configure a user interface at a terminal device becomes more convenient and incurs less usage of computing resources. Further, the support for installation of a theme package is no longer needed either, contributing to conserving the computing resources needed therefor.

FIG. 4 illustrates a functional diagram of an example system for configuring attributes associated with interface elements in accordance with an embodiment of the present disclosure. System 400 includes a notification receiving unit 402, and a configuring unit 404. Most of the functionalities performed by notification receiving unit 402 and configuring unit 404 are similar to those above-described with references to FIGS. 1-3. Therefore, for simplicity of illustration, details of these functionalities are not repeated herein.

Notification receiving unit 402 is configured to receive a notification including one or more attribute values.

Configuring unit 404 is configured to configure the attributes associated with interface elements based on the received attribute values.

In some embodiments, notification receiving unit 402 is configured to receive the notification broadcasted from an operating system. In some embodiments, notification receiving unit 402 is configured to receive the notification from an application or infrastructure applications.

In some embodiments, the notification is configured to include element identifiers corresponding to the respective attribute values. In this case, configuration unit 404 is configured to select from the elements of the application's interface that have identifiers matching with the received element identifiers. This way, the application of an attribute value to a mis-matching element (e.g., the element is not configurable using the attribute value) can be avoided, resulting in further decrease of the usage of computing resources during the course of configuring attributes of interface elements.

In some embodiments, system 400 is configured to transmit notifications to other applications or processes. In particular, system 400 can be configured to include a transmitting unit (not shown), which is configured to forward the notification to other applications or processes such that the other applications and/or processes are caused to determine whether to configure the attributes associated with their interface elements based on the notification.

According to various embodiments, the use of receiving notifications including attribute values results in system 400 being able to configure attributes associated with its interface elements based on the received notification. This way, the requirement or need to generate or download UI resource packages or content files is eliminated. As such, to update or configure a user interface at a terminal device becomes more convenient and incurs less usage of computing resources.

FIG. 5 illustrates a functional diagram of another example system for configuring attributes associated with interface elements in accordance with an embodiment of the present disclosure. System 500 includes a notification obtaining unit 502, and a notification transmitting unit 504. Most of the functionalities performed by notification obtaining unit 502 and notification transmitting unit 504 are similar to those above-described with references to FIGS. 1-3. Therefore, for simplicity of illustration, details of these functionalities are not repeated herein.

Notification obtaining unit 502 is configured to obtain the notification that signals for attribute configuration. The notification is configured to include one or more attribute values.

Notification transmitting unit 504 is configured to transmit the notification to an application, which in turn is caused to configure attributes associated with its interface elements based on the received attribute values.

In some embodiments, notification obtaining unit 502 is configured to obtain a notification by generating the notification or by receiving the notification.

In some embodiment, notification obtaining unit 502 is configured to generate a notification upon receiving a command to configure a wallpaper setting, a command to configure a theme setting, a command from a server to customize attribute values, or the like.

In some embodiments, system 500 is configured to further include an element identifier configuration unit (not shown). Any suitable techniques can be applied to assign identifiers to interface elements. For example, the element identifier configuration unit can first determine the functionalities associated with various interface elements, and then assign a same identifier to the elements having the same functionality, and different identifiers to elements having different functionality.

In some embodiments, system 500 is configured to further include a determination unit (not shown) and a configuration unit (not shown) such that system 500 is able to directly configure interface elements of an application. The determination unit is configured to, subsequent to notification transmitting unit 504 transmitting the notification to an application, determine the particular element identifiers and their respective attribute values the application has configured based on the received notification. The configuration unit is configured to, upon being triggered, directly configure the attributes of the application based on the determined element identifiers and attribute values used in the past configuration performed by the application itself.

The units described above can be implemented as software components executing on one or more processors, as hardware components such as programmable logic devices (e.g., microprocessors, field-programmable gate arrays (FPGAs), digital signal processors (DSPs), etc.), Application Specific Integrated Circuits (ASICs) designed to perform certain functions, or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present application. The units may be implemented on a single device or distributed across multiple devices. The functions of the units may be merged into one another or further split into multiple sub-sub-units.

FIG. 6 is a functional diagram illustrating an embodiment of a programmed computer system for configuring attributes associated with interface elements. As will be apparent, other computer system architectures and configurations can be used to configure attributes associated with interface elements. Computer system 600, which includes various subsystems as described below, includes at least one microprocessor subsystem (also referred to as a processor or a central processing unit (CPU)) 602. For example, processor 602 can be implemented by a single-chip processor or by multiple processors. In some embodiments, processor 602 is a general purpose digital processor that controls the operation of the computer system 600. Using instructions retrieved from memory 610, the processor 602 controls the reception and manipulation of input data, and the output and display of data on output devices (e.g., display 618). In some embodiments, processor 602 includes and/or is used to provide the launch of a client application based on a message.

Processor 602 is coupled bi-directionally with memory 610, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storages can also store programming instructions and data, in the form of data objects and text objects, in addition to other data and instructions for processes operating on processor 602. Also as is well known in the art, primary storage typically includes basic operating instructions, program code, data, and objects used by the processor 602 to perform its functions (e.g., programmed instructions). For example, memory 610 can include any suitable computer readable storage media, described below, depending on whether, for example, data access needs to be bi-directional or uni-directional. For example, processor 602 can also directly and very rapidly retrieve and store frequently needed data in a cache memory (not shown).

A removable mass storage device 612 provides additional data storage capacity for the computer system 600 and is coupled either bi-directionally (read/write) or uni-directionally (read only) to processor 602. For example, storage 612 can also include computer readable media such as magnetic tape, flash memory, PC-CARDS, portable mass storage devices, holographic storage devices, and other storage devices. A fixed mass storage 620 can also, for example, provide additional data storage capacity. The most common example of fixed mass storage 620 is a hard disk drive. Mass storage 612, 620 generally store additional programming instructions, data, and the like that typically are not in active use by the processor 602. It will be appreciated that the information retained within mass storages 612 and 620 can be incorporated, if needed, in standard fashion as part of memory 610 (e.g., RAM) as virtual memory.

In addition to providing processor 602 access to storage subsystems, bus 614 can also be used to provide access to other subsystems and devices. As shown, these can include a display 618, a network interface 616, a keyboard 604, and a pointing device 606, as well as an auxiliary input/output device interface, a sound card, speakers, and other subsystems as needed. For example, the pointing device 606 can be a mouse, stylus, track ball, or tablet, and is useful for interacting with a graphical user interface.

The network interface 616 allows processor 602 to be coupled to another computer, computer network, or telecommunications network using a network connection as shown. For example, through the network interface 616, the processor 602 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 602 can be used to connect the computer system 600 to an external network and transfer data according to standard protocols. For example, various process embodiments disclosed herein can be executed on processor 602, or can be performed across a network such as the Internet, intranet networks, or local area networks, in conjunction with a remote processor that shares a portion of the processing. Additional mass storage devices (not shown) can also be connected to processor 602 through network interface 616.

An auxiliary I/O device interface (not shown) can be used in conjunction with computer system 600. The auxiliary I/O device interface can include general and customized interfaces that allow the processor 602 to send and, more typically, receive data from other devices such as microphones, touch-sensitive displays, transducer card readers, tape readers, voice or handwriting recognizers, biometrics readers, cameras, portable mass storage devices, and other computers. Persons skilled in the art may clearly understand that, for the sake of descriptive convenience and streamlining, one may refer to the processes in the aforesaid method embodiments that correspond to specific work processes of the systems, devices, and units described above. They will not be discussed further here.

In one typical configuration, the computation equipment comprises one or more processors (CPUs), input/output interfaces, network interfaces, and memory.

Memory may include such forms as volatile storage devices in computer-readable media, random access memory (RAM), and/or non-volatile memory, such as read-only memory (ROM) or flash memory (flash RAM). Memory is an example of a computer-readable medium.

Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, (transitory media), such as modulated data signals and carrier waves.

A person skilled in the art should understand that embodiments of the present application can be provided as methods, systems, or computer program products. Therefore, the present application can take the form of an entirely hardware embodiment, an entirely software embodiment, or an embodiment that combines software and hardware aspects. In addition, the present application can take the form of computer program products implemented on one or more computer-operable storage media (including but not limited to magnetic disk storage devices, CD-ROMs, and optical storage devices) containing computer operable program codes.

The present application is described with reference to flowcharts and/or block diagrams based on methods, devices (systems), and computer program products of embodiments of the present application. Please note that each process and/or block within the flowcharts and/or block diagrams and combinations of processes and/or blocks within the flowcharts and/or block diagrams can be realized by computer commands. These computer program instructions can be provided to general-purpose computers, special-purpose computers, embedded processors, or processors of other data-processing devices to give rise to a machine such that the instructions by the computers or by the processors of other programmable data-processing devices give rise to devices used to implement the functions specified in one or more processes in a flowchart and/or in one or more blocks in a block diagram.

These computer program instructions can also be stored in computer-readable memory that can guide computers or other programmable data-processing devices to operate according to specific modes, with the result that the instructions stored in this computer-readable memory give rise to products that include command devices. These command devices implement the functions specified in one or more processes in a flow chart and/or one or more blocks in a block diagram.

These computer program instructions can also be loaded onto a computer or other programmable data-processing device, with the result that a series of operating steps are executed on a computer or other programmable device so as to give rise to computer processing. In this way, the instructions executed on a computer or other programmable device provide steps for implementing the functions specified by one or more processes in a flow chart and/or one or more blocks in a block diagram.

Although preferred embodiments of the present application have already been described, persons skilled in the art can make other alterations and modifications to these embodiments once they grasp the basic creative concept. Therefore, the attached claims are to be interpreted as including the preferred embodiments as well as all alterations and modifications falling within the scope of the present application.

Obviously, a person skilled in the art can modify and vary the present application without departing from the spirit and scope of the present application. Thus, if these modifications to and variations of embodiments of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
obtaining a notification, the notification including an attribute value associated with one or more interface elements; and
transmitting the notification to a receiving entity such that the receiving entity is caused to configure one or more attributes associated with interface elements based at least in part on the attribute value associated with the one or more interface elements.

2. The method of claim 1, wherein the obtaining of the notification comprises:
generating the notification to include the attribute value associated with the one or more interface elements; or
receiving the notification that includes the attribute value associated with the one or more interface elements.

3. The method of claim 2, wherein the generating of the notification comprises:
generating the notification subsequent to receiving a command to configure a wallpaper setting; or
generating the notification subsequent to receiving a command to configure a theme setting; or
generating the notification subsequent to receiving an attribute configuration notification from a server.

4. The method of claim 2, wherein the receiving of the notification comprises:
receiving the notification from a server or an application.

5. The method of claim 2, wherein the generating of the notification comprises:
determining a target color; and
generating the notification based on the determined target color, the notification including the target color as the attribute value associated with the one or more interface elements.

6. The method of claim 5, wherein the determining of the target color is based at least in part on at least one of the following:
a specified picture;
a specified event; and/or
a user selection of a color.

7. The method of claim 1, wherein the notification further includes one or more interface element identifiers corresponding to the attribute value associated with the one or more interface elements, respectively.

8. The method of claim 7, wherein the one or more interface element identifiers are configured by:
determining functionality associated with an interface element of an application's interface; and
assigning an interface element identifier to an interface element, wherein a same element identifier is assigned to interface elements having the same functionality, and wherein a different element identifier is assigned to interface elements having different functionality.

9. The method of claim 8, wherein the interface elements comprise one or more of the is following:
a button, a title bar, a toolbar, a selection box, a switch, a slider, a progress bar, and an input box.

10. The method of claim 1, subsequent to transmitting the notification, further comprising:
recording interface element identifiers that correspond to the attributes that the receiving entity has configured based on the attribute value associated with the one or more interface elements; and
configuring, based on a triggering condition, receiving entity's attributes of elements corresponding to the recorded interface element identifiers based on the recorded one or more attribute values.

11. The method of claim 1, wherein the notification comprises interface element identifiers corresponding to the attribute value associated with the one or more interface elements.

12. A method, comprising:
receiving a notification, the notification including attribute value associated with the one or more interface elements; and
configuring, based at least in part on the received attribute values, the attributes associated with the interface elements.

13. The method of claim 12, wherein the receiving of the notification comprises:
receiving the notification broadcasted from an operating system; or
receiving the notification from another application.

14. The method of claim 12, wherein the notification includes at least two attribute values, and wherein the configuring of the attributes associated with the interface elements comprises:
selecting an attribute value based on the at least two attribute values; and
configuring, by use of the selected attribute value, the attributes associated with the interface elements.

15. The method of claim 12, wherein the notification further includes interface element identifiers corresponding to the one or more attribute values respectively, and wherein the configuring of the attributes associated with the interface elements comprises:
selecting, based at least in part on the interface element identifiers corresponding to the attribute value associated with the one or more interface elements, attribute values that correspond to interface element identifiers matching with element identifiers of the interface elements; and
configuring, with the selected attribute values, the attributes associated with the interface elements.

16. The method of claim 12, wherein the configuring of the attributes associated with the interface elements comprises:
computing, based on the attribute value associated with the one or more interface elements and a pre-configured set of mapping rules, other attribute values; and
configuring, with the computed other attribute values, the attributes associated with the interface elements.

17. The method of claim 12, wherein the notification further includes interface element identifiers corresponding to the attribute value associated with the one or more interface elements respectively, and wherein the configuring of the attributes associated with the interface elements comprises:
configuring the attributes of interface elements having element identifiers matching with the element identifiers in the notification.

18. The method as described in claim 12, further comprising:
transmitting another notification to another application, the another notification including the attribute value associated with the one or more interface elements; and
causing the another application to configure attributes associated with interface elements of the another application based on the another notification.

19. A system, comprising:
one or more processors configured to:
receive a notification, the notification including attribute value associated with the one or more interface elements; and
configure, based at least in part on the received attribute values, the attributes associated with the interface elements; and
one or more memories coupled to the one or more processors, configured to provide the one or more processors with instructions.

20. A computer program product, the computer program product being embodied in a tangible computer readable storage medium and comprising computer instructions for:
receiving a notification, the notification including attribute value associated with the one or more interface elements; and
configuring, based at least in part on the received attribute values, attributes associated with interface elements.
